(19) United States
(12) Patent Application Publication
(10) Pub. No.: US 2026/0275782 A1
(43) Pub. Date: Sep. 17, 2026

(54) HINGE DEVICE

(71) Applicant: FOSITEK CORPORATION, New Taipei City (TW)

(72) Inventors: Yung-Chih TSENG, New Taipei City (TW); Zoen Ryon Ryan Wong, New Taipei City (TW)

(73) Assignee: FOSITEK CORPORATION, New Taipei City (TW)

(21) Appl. No.: 19/207,893

(22) Filed: May 14, 2025

(30) Foreign Application Priority Data
Mar. 14, 2025 (TW) 114109557

(51) Int. Cl. E05D 3/18

(52) U.S. Cl. CPC E05D 3/18; E05Y 2201/71

(57) ABSTRACT

A hinge device includes a base seat, a rotating unit, a translating slider, and a rotating foot cushion member. The rotating unit includes a rotating member rotatable relative to the base seat between first and second positions and a first connecting protrusion. The translating slider is slidably movable relative to the base seat between first and second translation positions. The rotating foot cushion member is rotatable relative to the base seat between folded and supporting positions. When the rotating member is in the first position, the translating slider is in the first translation position, and the rotating foot cushion member is in the folded position. When the rotating member rotates to the second position, the translating slider is driven to slide to the second translation position by the first connecting protrusion, thereby driving the rotating foot cushion member to rotate to the supporting position.

### CROSS-REFERENCE TO RELATED APPLICATION

This application claims priority to Taiwanese Invention Patent Application No. 114109557, filed on March 14, 2025, the entire disclosure of which is incorporated by reference herein.

### FIELD

The disclosure relates to a hinge, and more particularly to a hinge device that may be used in electronic devices such as a laptop computer.

### BACKGROUND

Typically, when a user use an electronic device such as a laptop computer, he/she often needs to elevate a back side of the laptop computer using a stand to dissipate heat and to increase comfort of using the laptop computer's keyboard. However, the aforementioned stand is not convenient to store or use, and there is still room for improvement of its stability. Therefore, how to conveniently and stably elevate the back side of the laptop computer is a problem to be solved.

### SUMMARY

Therefore, an object of the disclosure is to provide a hinge device that can alleviate at least one of the drawbacks of the prior art.

According to the disclosure, the hinge device includes a base seat, a rotating unit, a translating slider, and a rotating foot cushion member. The rotating unit includes a rotating member and a first connecting protrusion. The rotating member is mounted on the base seat and is rotatable relative to the base seat about a first rotational axis parallel to a left-right direction between a first position and a second position. The first connecting protrusion is driven by the rotating member and is rotatable relative to the base seat about a second rotational axis parallel to the left-right direction. The translating slider is mounted on the base seat and is slidably movable relative to the base seat between a first translation position and a second translation position along a front-rear direction. The translating slider has a first concave rail and a second concave rail recessed along the left-right direction. The first connecting protrusion of the rotating unit is slidably mounted in the first concave rail, and the second concave rail extends in an up-down direction. The rotating foot cushion member is pivotably mounted on the base seat and is rotatable relative to the base seat about a third rotational axis parallel to the left-right direction between a folded position and a supporting position. The rotating foot cushion member has a foot connecting protrusion slidably mounted in the second concave rail at one end thereof, a foot cushion body mounted at another end thereof, and a pivot connecting portion pivotably connected to the base seat and located between the foot connecting protrusion and the foot cushion body. When the rotating member is in the first position, the translating slider is in the first translation position, the rotating foot cushion member is in the folded position, and the foot cushion body of the rotating foot cushion member is relatively close to the base seat. When the rotating member rotates to the second position, the translating slider is driven to slide along the front-rear direction to the second translation position by the first connecting protrusion, thereby driving the rotating foot cushion member to rotate to the supporting position, and the foot cushion body of the rotating foot cushion member is relatively far from the base seat.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic side view of an embodiment of a hinge device according to the present disclosure disposed on an electronic device, illustrating a rotating member of a rotating unit of the embodiment in a first position.

FIG. 2 is a perspective view of the embodiment.

FIG. 3 is a perspective view of the embodiment taken from another angle.

FIG. 4 is a partly exploded perspective view of FIG. 2.

FIG. 5 is a partly exploded perspective view of FIG. 3.

FIG. 6 is another schematic side view of the embodiment disposed on the electronic device, illustrating the rotating member of the rotating unit of the embodiment being located between the first position and a transition position.

FIG. 7 is still another schematic side view of the embodiment disposed on the electronic device, illustrating the rotating member of the rotating unit of the embodiment in the transition position.

FIG. 8 is still another schematic side view of the embodiment disposed on the electronic device, illustrating the rotating member of the rotating unit of the embodiment in a second position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

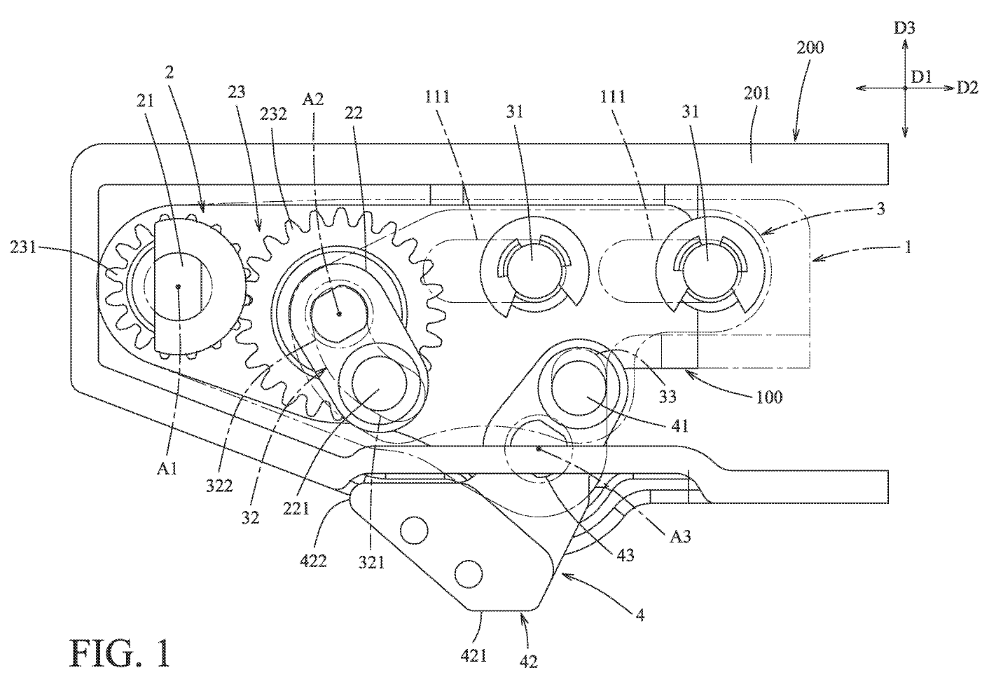

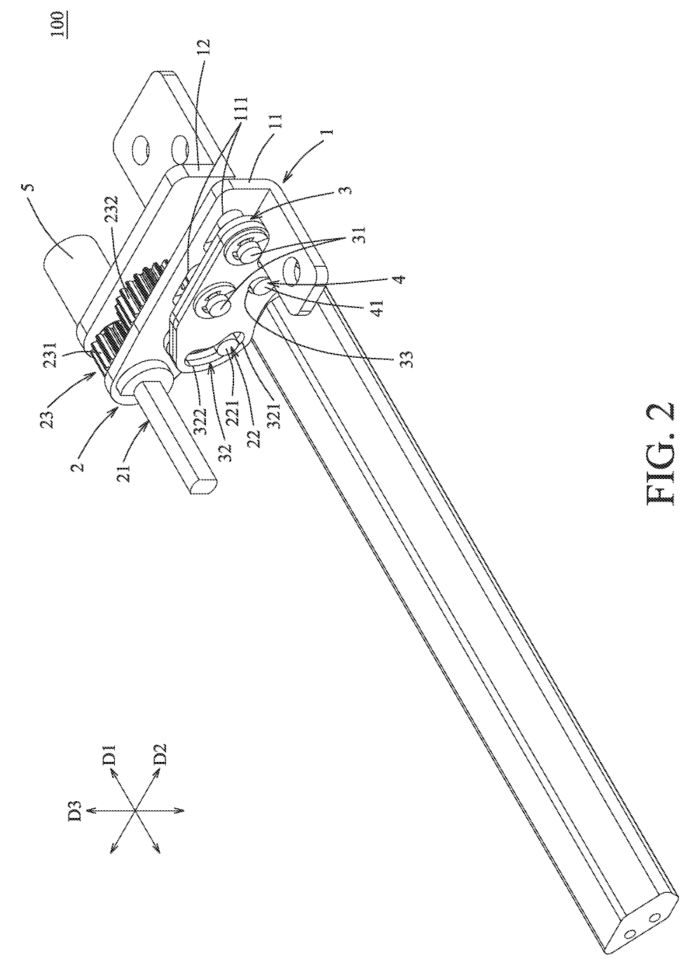

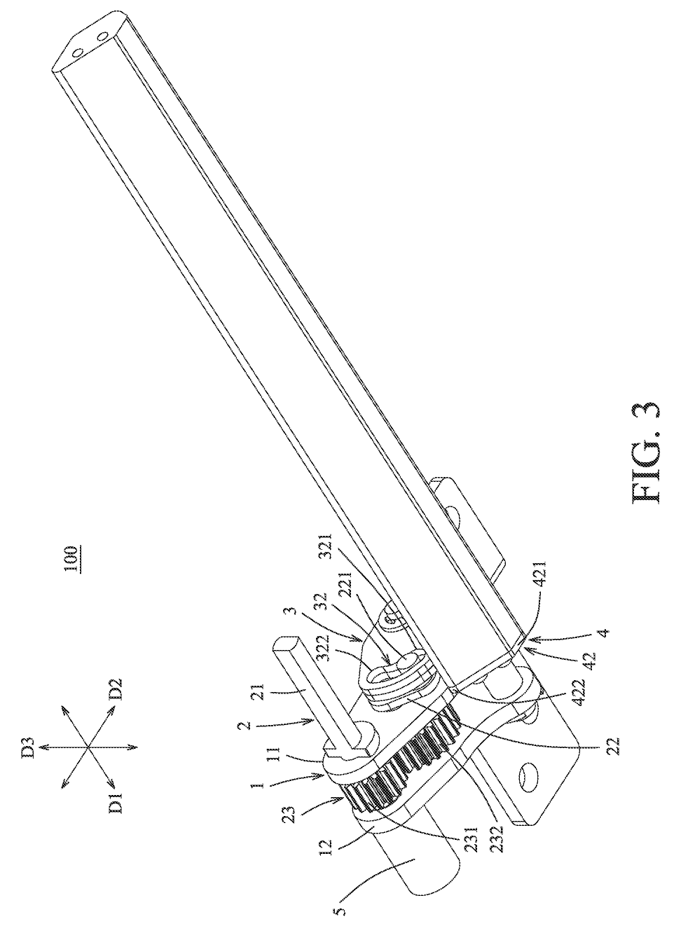

Referring to FIGS. 1 to 3, an embodiment of the hinge device 100 according to the disclosure is adapted for an electronic device 200. The electronic device 200 may be exemplified as a notebook computer but is not limited thereto. The electronic device 200 includes a first housing 201 and a second housing (not shown). The first housing 201 may include a keyboard, a screen, and a touchpad (not shown). The hinge device 100 is connected between the first housing 201 and the second housing to allow the second housing to open and close relative to the first housing 201. The hinge device 100 includes a base seat 1, a rotating unit 2, a translating slider 3, and a rotating foot cushion member 4.

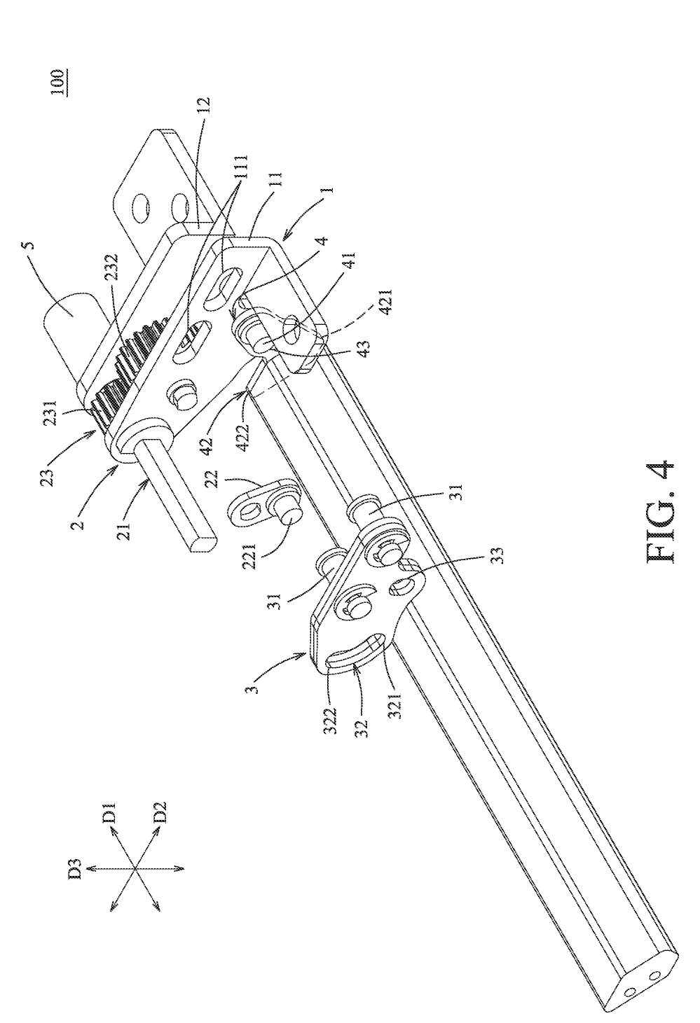

Referring to FIGS. 1 to 4, the base seat 1 is adapted to be mounted on the first housing 201. The base seat 1 includes a first seat body 11 and a second seat body 12 arranged in a left-right direction (D1), and the first seat body 11 and the second seat body 12 are used to be mounted on a back side of the first housing 201 in a front-rear direction (D2). The first seat body 11 of the base seat 1 has two guiding grooves 111 recessed in the left-right direction (D1) and extending in the front-rear direction (D2). For example, the two guiding grooves 111 are arranged in the front-rear direction (D2).

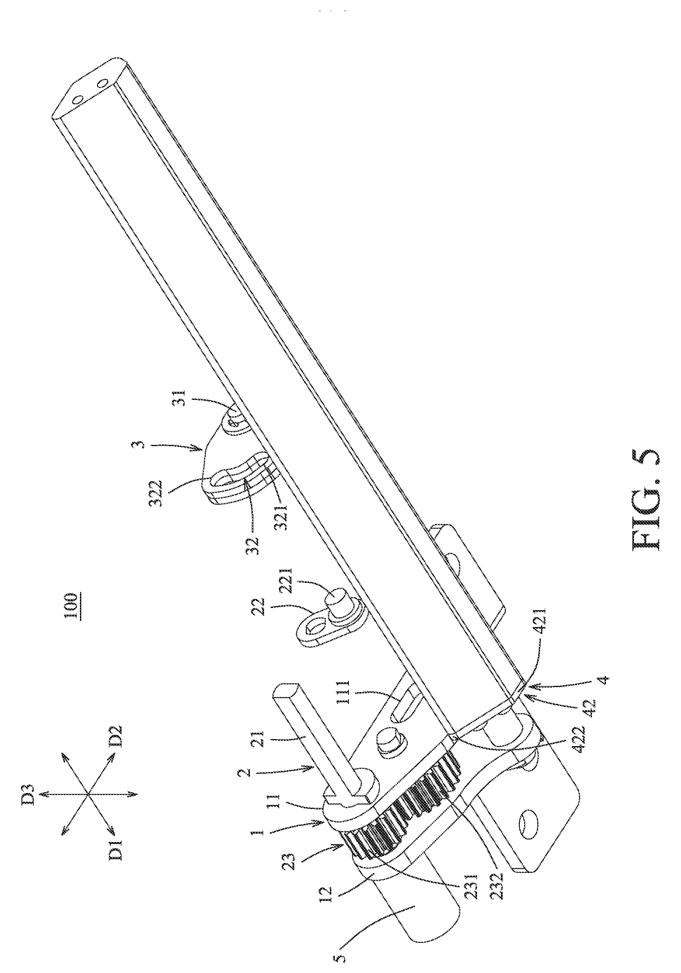

Referring to FIGS. 1 to 5, the rotating unit 2 includes a rotating member 21, a rotary rod 22, and a driving gear unit 23. The rotating member 21 is mounted on the base seat 1, is adapted to support the second housing, is rotatable relative to the base seat 1 about a first rotational axis (A1) parallel to the left-right direction (D1) between a first position and a second position, and moves to a transition position during rotation from the first position to the second position. The rotary rod 22 has a first connecting protrusion 221 disposed at a distal end thereof. The driving gear unit 23 is connected between the rotating member 21 and the rotary rod 22, and includes a driving gear 231 and a driven gear 232 located between the first seat body 11 and the second seat body 12 of the base seat 1. The driving gear 231 is sleeved on the rotating member 21 and rotates synchronously with the rotating member 21 about the first rotational axis (A1), while the driven gear 232 is disposed on the base seat 1 and meshes with the driving gear 231. The rotary rod 22 is mounted on the driven gear 232 and rotates synchronously with the driven gear 232. Through transmission of the driving gear unit 23, the first connecting protrusion 221 (the rotary rod 22 as well) is connected to the rotating member 21 and may rotate relative to the base seat 1 about a second rotational axis (A2) parallel to the left-right direction (D1), and a rotation direction of the first connecting protrusion 221 (the rotary rod 22) is opposite to that of the rotating member 21. It should be noted that in other embodiments, the first connecting protrusion 221 may also be directly formed on the rotating member 21, in which case the second rotational axis (A2) coincides with the first rotational axis (A1), and a rotation axis and the rotation direction of the first connecting protrusion 221 are same as those of the rotating member 21.

The translating slider 3 is mounted on the base seat 1, and includes two guiding studs 31 that protrude in the left-right direction (D1) and that are disposed respectively and slidably in the guiding grooves 111, thereby allowing the translating slider 3 to be slidably movable relative to the base seat 1 between a first translation position and a second translation position along the front-rear direction (D2). The translating slider 3 has a first concave rail 32 and a second concave rail 33 recessed in the left-right direction (D1). The first concave rail 32 has a driving portion 321 and an arcuate rail portion 322 that are connected to each other, and a radius of curvature of the arcuate rail portion 322 is equal to a distance between the first connecting protrusion 221 and the second rotational axis (A2). In this embodiment, the driving portion 321 is straight and tangent to the arcuate rail portion 322, but in other embodiments, the driving portion 321 may not be straight, and may be adjusted according to actual requirements. The first connecting protrusion 221 of the rotating unit 2 is slidably mounted in the first concave rail 32. The second concave rail 33 extends in an up-down direction (D3).

The rotating foot cushion member 4 is partially located between the base seat 1 and the translating slider 3 and is pivotably mounted on the base seat 1. The rotating foot cushion member 4 is rotatable relative to the base seat 1 about a third rotational axis (A3) parallel to the left-right direction (D1) between a folded position and a supporting position. The rotating foot cushion member 4 includes a foot connecting protrusion 41 at one end thereof slidably mounted in the second concave rail 33, a foot cushion body 42 at another end thereof, and a pivot connecting portion 43 pivotably connected to the base seat 1 and located between the foot connecting protrusion 41 and the foot cushion body 42. The second concave rail 33 may permit displacement of the foot connecting protrusion 41 in the up-down direction (D3) when the rotating foot cushion member 4 rotates. The foot cushion body 42 of the rotating foot cushion member 4 has a first foot cushion portion 421 that is closer to the pivot connecting portion 43 and a second foot cushion portion 422 that is farther from the pivot connecting portion 43.

Additionally, in this embodiment, a torque friction member 5 may be further disposed on the rotating member 21 to rotate synchronously with the rotating member 21, so as to generate a frictional force with the second seat body 12 of the base seat 1 to resist rotation of the rotating member 21, thereby enabling the electronic device 200 to be positioned at various angles and enhancing a user's tactile experience when opening and closing the electronic device 200.

Referring to FIG. 1, when the rotating member 21 is in the first position, the second housing is closed relative to the first housing 201. At this time, the first connecting protrusion 221 is located at an intersection of the driving portion 321 and the arcuate rail portion 322. The translating slider 3 is in the first translation position, and the rotating foot cushion member 4 is in the folded position. It should be noted that, although the first connecting protrusion 221 is located at the intersection of the driving portion 321 and the arcuate rail portion 322 at this time, depending on a shape of the driving portion 321 and a planned motion path of the first connecting protrusion 221, the first connecting protrusion 221 may also be in the driving portion 321, not at the intersection of the driving portion 321 and the arcuate rail portion 322, and not limited to this embodiment. In this state, the foot cushion body 42 of the rotating foot cushion member 4 is relatively close to the base seat 1, and the first foot cushion portion 421 is lower than the second foot cushion portion 422 in position.

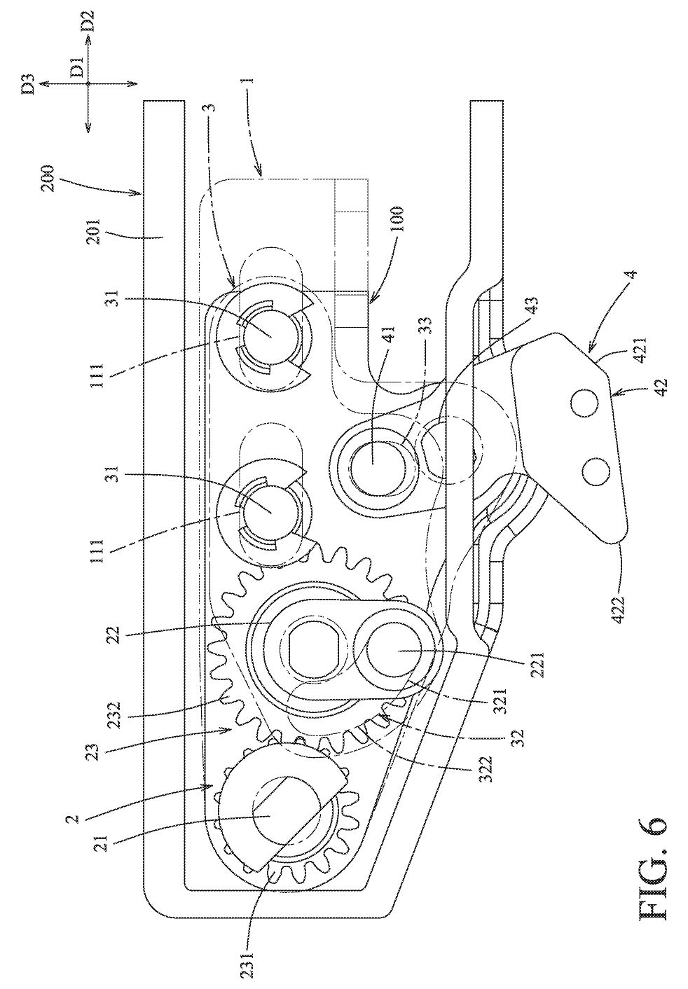

Referring to FIG. 6, when the rotating member 21 rotates from the first position to a position between the first position and the transition position, the second housing is open relative to the first housing 201 by approximately 45 degrees, the first connecting protrusion 221 slides to an end of the driving portion 321, thereby driving the translating slider 3 to slide rearward in the front-rear direction (D2) towards the second translation position, and further urging the rotating foot cushion member 4 to rotate towards the supporting position.

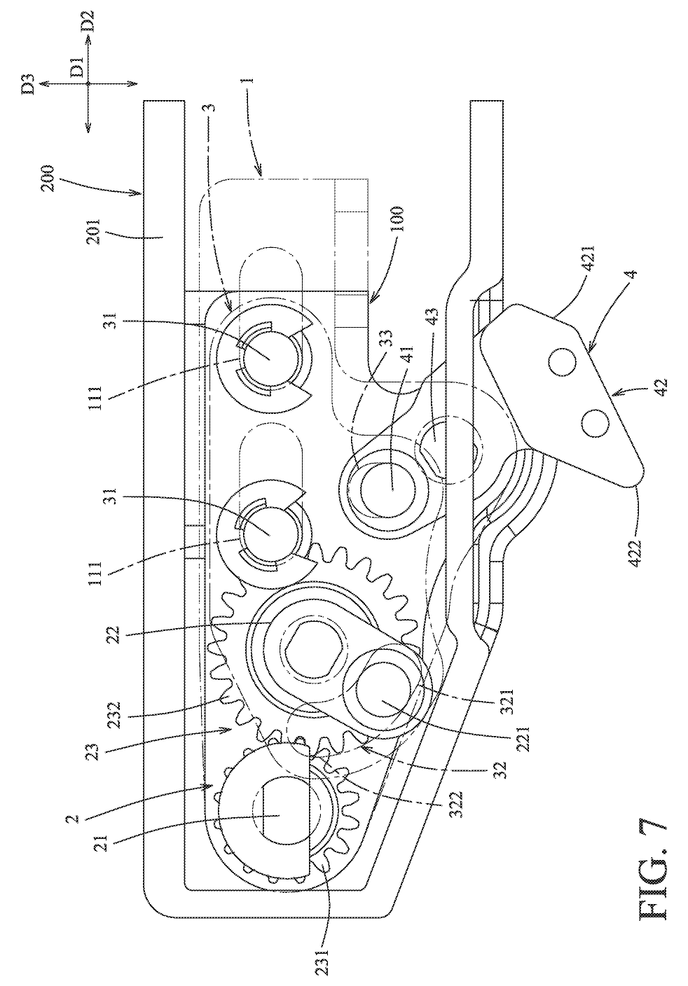

Referring to FIG. 7, when the rotating member 21 continues to rotate to the transition position, the second housing is open relative to the first housing 201 by approximately 90 degrees. At this point, the first connecting protrusion 221 returns to the intersection of the driving portion 321 and the arcuate rail portion 322, and the first connecting protrusion 221 drives the translating slider 3 to slide in the front-rear direction (D2) to the second translation position, thereby driving the rotating foot cushion member 4 to rotate to the supporting position. In this state, the foot cushion body 42 of the rotating foot cushion member 4 is relatively far from the base seat 1, and the second foot cushion portion 422 is lower than the first foot cushion portion 421 in position. It should be noted that the second foot cushion portion 422 (a portion adapted for support) of the foot cushion body 42 of the rotating foot cushion member 4 is roughly located below the pivot connecting portion 43 of the rotating foot cushion member 4, so that a reaction force received by the foot cushion body 42 is not easily converted into a torque that causes the rotating foot cushion member 4 to rotate relative to the base seat 1, thereby preventing the rotating foot cushion member 4 from returning to the folded position.

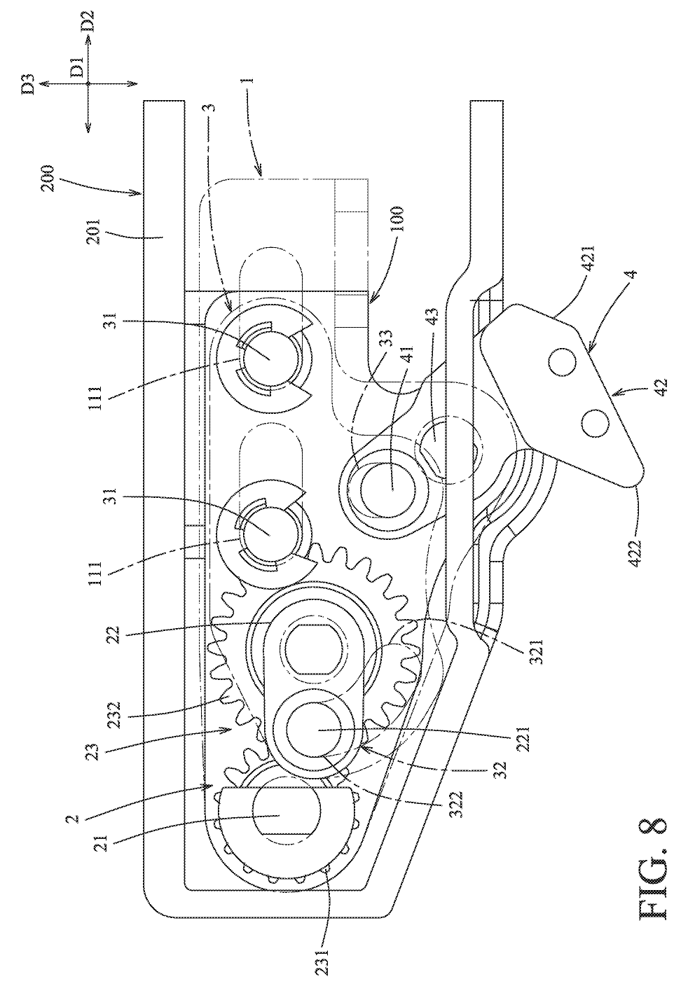

Referring to FIG. 8, when the rotating member 21 rotates from the transition position to the second position, the second housing is open relative to the first housing 201 by approximately 180 degrees, the first connecting protrusion 221 slides along the arcuate rail portion 322 to an end of the arcuate rail portion 322, the translating slider 3 does not slide (i.e., is not moved by the first connecting protrusion 221), and the rotating foot cushion member 4 does not rotate (i.e., is not moved because the translating slider 3 is not moved). It should be noted that since a distance between the first connecting protrusion 221 of the rotary rod 22 and the second rotational axis (A2) is fixed and equal to the radius of curvature of the arcuate rail portion 322, when the first connecting protrusion 221 is in the arcuate rail portion 322, the translating slider 3 is being restricted in the second translation position and does not slide, and the rotating foot cushion member 4 is also being restricted in the supporting position and does not rotate, thereby preventing the rotating foot cushion member 4 from returning to the folded position.

In summary, by virtue of the synchronous movement of the rotating member 21 and the translating slider 3, when the rotating member 21 rotates from the first position to the second position, the rotating foot cushion member 4 may be rotated downward from the folded position to the supporting position. Therefore, when the hinge device 100 is used on the electronic device 200 such as the notebook computer, the rotating foot cushion member 4 may be conveniently used to elevate a back side of the notebook computer. Moreover, by virtue of the driving portion 321 and the arcuate rail portion 322 of the first concave rail 32, when the first connecting protrusion 221 is in the arcuate rail portion 322, the translating slider 3 is restricted in the second translation position and does not slide, and the rotating foot cushion member 4 is restricted in the folded position and does not rotate, thereby preventing the rotating foot cushion member 4 from returning to the folded position.

In the description above, for the purposes of explanation, numerous specific details have been set forth in order to provide a thorough undersupporting of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A hinge device, comprising:
a base seat;
a rotating unit including a rotating member and a first connecting protrusion, said rotating member being mounted on said base seat and rotatable relative to said base seat about a first rotational axis parallel to a left-right direction between a first position and a second position, said first connecting protrusion being driven by said rotating member and rotatable relative to said base seat about a second rotational axis parallel to the left-right direction;
a translating slider mounted on said base seat and being slidably movable relative to said base seat between a first translation position and a second translation position along a front-rear direction, said translating slider having a first concave rail and a second concave rail recessed along the left-right direction, said first connecting protrusion of said rotating unit being slidably mounted in said first concave rail, said second concave rail extending in an up-down direction; and
a rotating foot cushion member pivotably mounted on said base seat and being rotatable relative to said base seat about a third rotational axis parallel to the left-right direction between a folded position and a supporting position, said rotating foot cushion member having a foot connecting protrusion slidably mounted in said second concave rail at one end thereof, a foot cushion body mounted at another end thereof, and a pivot connecting portion pivotably connected to said base seat and located between said foot connecting protrusion and said foot cushion body;
wherein, when said rotating member is in the first position, said translating slider is in the first translation position, said rotating foot cushion member is in the folded position, and said foot cushion body of said rotating foot cushion member is relatively close to said base seat;
wherein, when said rotating member rotates to the second position, said translating slider is driven to slide along the front-rear direction to the second translation position by said first connecting protrusion, thereby driving said rotating foot cushion member to rotate to the supporting position, and said foot cushion body of said rotating foot cushion member is relatively far from said base seat.

2. The hinge device as claimed in claim 1, wherein said rotating member moves to a transition position during rotation from the first position to the second position, said first concave rail having a driving portion, and an arcuate rail portion connected to said driving portion, a radius of curvature of said arcuate rail portion being equal to a distance between said first connecting protrusion and the second rotational axis, said first connecting protrusion sliding towards said driving portion and then returning to an intersection of said driving portion and said arcuate rail portion when said rotating member rotates from the first position to the transition position, thereby driving said translating slider to slide in the front-rear direction to the second translation position, so as to drive said rotating foot cushion member to rotate to the supporting position, said first connecting protrusion sliding along said arcuate rail portion when said rotating member rotates from the transition position to the second position, said translating slider and said rotating foot cushion member being not moved when said rotating member rotates from the transition position to the second position.

3. The hinge device as claimed in claim 2, wherein said driving portion is straight and is tangent to said arcuate rail portion.

4. The hinge device as claimed in claim 1, wherein said base seat has a plurality of guiding grooves recessed in the left-right direction and that extend in the front-rear direction, said translating slider including a plurality of guiding studs disposed respectively and slidably in said plurality of guiding grooves.

5. The hinge device as claimed in claim 1, wherein said rotating unit further includes a rotary rod, said rotary rod being driven by said rotating member and being rotatable relative to said base seat about the second rotational axis, said rotary rod having said first connecting protrusion disposed at a distal end thereof.

6. The hinge device as claimed in claim 5, wherein said rotating unit further comprises a driving gear unit connected between said rotating member and said rotary rod, said driving gear unit including a driving gear and a driven gear, said driving gear being sleeved on said rotating member and rotating synchronously with said rotating member, said driven gear being disposed on said base seat and meshing with said driving gear, said rotary rod being mounted on said driven gear and rotating synchronously with said driven gear.

7. The hinge device as claimed in claim 1, wherein said foot cushion body of said rotating foot cushion member has a first foot cushion portion that is closer to said pivot connecting portion and a second foot cushion portion that is farther from said pivot connecting portion, when said rotating foot cushion member is in the folded position, said first foot cushion portion being lower than said second foot cushion portion in position, when said rotating foot cushion member is in the supporting position, said second foot cushion portion being lower than said first foot cushion portion in position.
